(19) United States
(12) Patent Application Publication
(10) Pub. No.: US 2013/0180916 A1
(43) Pub. Date: Jul. 18, 2013

(54) BIOLOGICAL PURIFIER, BIOLOGICAL PURIFICATION SYSTEM, AND BIOLOGICAL PURIFICATION METHOD FOR UNTREATED WASTE WATER

(71) Applicants: Hisatoshi Furuya, Minato-ku (JP); Nobuyuki Masuda, Minato-ku (JP); Atsushi Osame, Minato-ku (JP); Mikio Kobayashi, Minato-ku (JP); Hideo Asano, Minato-ku (JP); Masao Okumura, Minato-ku (JP); Hidekatsu Nakamura, Minato-ku (JP); Ayumi Kurosaka, Minato-ku (JP)

(72) Inventors: Hisatoshi Furuya, Minato-ku (JP); Nobuyuki Masuda, Minato-ku (JP); Atsushi Osame, Minato-ku (JP); Mikio Kobayashi, Minato-ku (JP); Hideo Asano, Minato-ku (JP); Masao Okumura, Minato-ku (JP); Hidekatsu Nakamura, Minato-ku (JP); Ayumi Kurosaka, Minato-ku (JP)

(73) Assignee: JAPAN OIL, GAS AND METALS NATIONAL CORPORATION, Tokyo (JP)

(21) Appl. No.: 13/824,840

(22) PCT Filed: Dec. 13, 2011
(86) PCT No.: PCT/JP2011/079270

§ 371 Date: Mar. 26, 2013

(30) Foreign Application Priority Data
Dec. 13, 2010 (JP) 2010-277039

(51) Int. Cl. C02F 3/34

(52) U.S. Cl. CPC C02F 3/345
USPC 210/616; 210/287; 435/252.1

(57) ABSTRACT

A biological purifier of the present invention includes chaff retaining sulfate-reducing bacteria. A biological purification system of the present invention includes a treatment container in which anaerobic conditions are maintained, and the above biological purifier is stored; a supply system for supplying the untreated waste water into the treatment container; and an discharge system for discharging treated water from which the heavy metal ions have been removed in the treatment container by the purifier, from the treatment container. In a biological purification method of the present invention, the biological purifier and the untreated waste water are brought into contact with each other under anaerobic conditions, thereby precipitating and removing the heavy metal ions as sulfide from the untreated waste water.

### TECHNICAL FIELD

The present invention relates to a biological purifier, a biological purification system, and a biological purification method for removing heavy metal ions from untreated waste water containing heavy metal ions and sulfate ions.

### RELATED ART

Various types of wastewaters, for example, wastewater generated by mining operations such as drainage from metal mines, and industrial wastewater contain various types of heavy metal ions. Many of heavy metal ions have harmful effects on human bodies or the environment. Therefore, water containing such heavy metal ions must be treated to meet effluent standards prescribed by each country, before being discharged.

Further, recently, some countries and areas are likely to make effluent standards stricter than at present thereby reducing environmental pollution. Accordingly, there are pressing needs for developing techniques for minimizing the concentration of heavy metal ions contained in untreated waste water at low cost.

Various types of wastewaters such as mine drainage or industrial wastewater generally contain ions of heavy metals such as Fe, Zn, Cu, Pb, Cd, and As, and may further contain about 50-3000 mg/L of sulfate ions (SO₄²⁻).

Techniques for removing heavy metal ions contained in such untreated waste water include, for example, a method of adding an alkaline agent such as calcium hydroxide or calcium carbonate into untreated waste water thereby neutralizing the untreated waste water to precipitate heavy metal ions as hydroxide or carbonate and a method of artificially adding a sulfurizing agent such as hydrogen sulfide to untreated waste water thereby precipitating heavy metal ions as sulfide.

However, the method of adding an alkaline agent requires a neutralization process for neutralizing untreated waste water while stirring it with an electric motor or the like, and a subsequent solid-liquid separation process for separating the precipitate generated in the neutralization. Further, some elements to be treated (Zn, Pb, and Cd in particular) may require a large amount of chemicals such as a neutralizer. Furthermore, since a large amount of precipitate (sludge) is generated, routine maintenance and a large area of land reserved for accumulating the precipitate are required. This requires costs associated with them, for example, costs involved with the use of chemicals (alkaline agent), consumption of electric power, solid-liquid separation operations, which is a problem.

On the other hand, the method of adding a sulfurizing agent has a disadvantage in that it is dangerous because hydrogen sulfide, which is a toxic gas, is actively produced, which requires close supervision.

Therefore, as a method using environment-friendly technique for purifying untreated waste water, a method using biomass resources which have been unutilized and wasted as unnecessary products has been attracting attention recently.

Patent Document 1 (JP 6-39277A) discloses, as a method using unutilized biomass resources, a method of producing active rice husks having increased surface area and adsorption ability, characterized in that inorganic acid and/or alkali are added to carbonized rice husks or silver-white rice husks, followed by subsequent heating, filtration, and desiccation. Patent Document 2 (JP 2008-23440A) discloses a water treatment method characterized by bringing untreated waste water containing heavy metals into contact with buckwheat husks to make the heavy metals in the untreated waste water adsorbed onto the buckwheat husks.

The methods disclosed in Patent Document 1 and 2 are focused on adsorption for removing heavy metal ions in untreated waste water. However, high capability of removing heavy metal ions cannot be maintained for a long period only by the adsorption. Accordingly, costs and efforts for solving this problem have been a great burden.

In view of the above, in recent years, as methods of removing heavy metal ions without using adsorption, techniques of using the action of sulfate-reducing bacteria to remove heavy metal ions from untreated waste water containing sulfate ions have been studied.

Patent Document 3 (JP 2010-269249A) discloses a technique of removing heavy metal ions from untreated waste water, in which in an artificial wetland, sulfate ions are reduced to produce sulfide ions by sulfate-reducing bacteria, and by reaction of these sulfide ions with the heavy metal ions, sulfide of the heavy metals is produced to be precipitated and separated. This document describes that organic matter such as lactic acid, a fertilizer, or potting soil is supplied as an energy source for sulfate-reducing bacteria, to the artificial wetland. Further, Non-Patent Document 1 (Passive Treatment of Acid Mine Drainage in Bioreactors using Sulfate-Reducing Bacteria: Critical Review and Research Needs) discloses the use of hay, wood chips, cattle manure, and the like as energy sources for sulfate-reducing bacteria.

### PRIOR ART DOCUMENTS

### Patent Documents

Patent Document 1: Japanese Patent Application Publication No. 6-39277
Patent Document 2: Japanese Patent Application Publication No. 2008-23440
Patent Document 3: Japanese Patent Application Publication No. 2010-269249

### Non-Patent Documents

Non-Patent Document 1: Passive Treatment of Acid Mine Drainage in Bioreactors using Sulfate-Reducing Bacteria: Critical Review and Research Needs, Carmen-Mihaela et al., J. Environ. Qual. 36, 1-16 (2007)

### DISCLOSURE OF THE INVENTION

### Problems to be Solved by the Invention

The inventors of the present invention have made various studies to find and select a biological purifier that contains sulfate-reducing bacteria and organic matter source serving as an energy source for the relevant sulfate-reducing bacteria and is capable of sufficiently removing heavy metal ions as sulfide from untreated waste water containing heavy metal ions and sulfate ions for a long period by simple contact with the untreated waste water for a predetermined time. In these studies, they have found that some of the known organic matter sources serving as energy sources for sulfate-reducing bacteria can make the action of sulfate-reducing bacteria effective while the others cannot exert such action. Accordingly, there has been a need for selecting an appropriate organic matter source so that sulfate-reducing bacteria can reduce sulfate ions to produce sulfide ions in a reaction, thereby removing heavy metal ions as sulfide.

Further, they found that depending on the types of organic matter sources, organic matter was mixed into treated water which has been purified, possibly resulting in an increased value of chemical oxygen demand (COD) of the treated water and that this tendency was particularly significant in water treated in an early stage in purification, and the water could be colored. When a purifier containing such an organic matter source is used, treated water (water treated in an early stage in particular) needs to be subjected to additional processes for removing the organic matter, which takes time and money.

Moreover, in order to achieve the practical use of such a purification system for treating large quantities of untreated waste water, a substantial amount of organic matter source is required; therefore, the cost of organic matter source itself should also be taken into consideration. Hay, wood chips, and cattle manure which have been known as organic matter sources serving as energy sources for sulfate-reducing bacteria are effective for other applications such as livestock feed, plant fertilizers, fuels, and the like, and they may be obtained at low cost but they are not always free. Therefore, it is preferable to make effective use of unutilized biomass resources most of which have been wasted. However, no other studies have been focused on positive use of unutilized biomass resources that are readily available at little cost in large quantities as organic matter sources serving as energy sources for sulfate-reducing bacteria.

In view of the above problems, it is therefore an object of the present invention to provide a biological purifier including unutilized biomass resource capable of sufficiently removing heavy metal ions in untreated waste water that contains heavy metal ions and sulfate ions for a long period and capable of sufficiently suppressing organic contamination of treated water; a biological purification system using the biological purifier; and a biological purification method using the biological purifier.

### Means for Solving the Problem

In order to achieve the above object, the present invention primarily includes the following components.

A biological purifier of the present invention for untreated waste water containing heavy metal ions and sulfate ions to remove the heavy metal ions from the untreated waste water as sulfide comprises chaff retaining sulfate-reducing bacteria.

With respect to the biological purifier for untreated waste water of the present invention, the chaff is preferably fermented under anaerobic conditions and the chaff may be rice husks or buckwheat husks.

A biological purification system of the present invention for untreated waste water containing heavy metal ions and sulfate ions to remove the heavy metal ions from the untreated waste water, comprises:
a treatment container in which anaerobic conditions are maintained, and the above biological purifier is stored;
a supply system for supplying the untreated waste water into the treatment container; and
an discharge system for discharging treated water from which the heavy metal ions have been removed in the treatment container by the biological purifier, from the treatment container.

Further, the biological purification system for untreated waste water of the present invention is preferably configured such that the untreated waste water can pass through the supply system, the treatment container, and the discharge system in this order with gravity.

A biological purification method of the present invention for untreated waste water containing heavy metal ions and sulfate ions to remove the heavy metal ions from the untreated waste water is the method, wherein the above biological purifier and the untreated waste water are brought into contact with each other under anaerobic conditions, thereby precipitating and removing the heavy metal ions as sulfide from the untreated waste water.

In the method, the untreated waste water may be mine drainage.

### Effect of the Invention

According to the present invention, a biological purifier including unutilized biomass resource capable of sufficiently removing heavy metal ions in untreated waste water that contains heavy metal ions and sulfate ions for a long period and capable of sufficiently suppressing organic contamination of treated water; a biological purification system using the biological purifier; and a biological purification method using the biological purifier can be provided.

### BRIEF DESCRIPTION OF THE DRAWINGS

FIG. 1 includes the upper photographs showing bark compost with cow manure, leaf mold, and rice husks from the left, and the lower photographs showing the measurement of concentration of hydrogen sulfide gas generated by mixing those organic matters: 20 mL with untreated waste water generated by mining operations (pH: 5.91, Cd ion concentration: 0.1 mg/L, SO₄²⁻ concentration: 250 mg/L): 20 mL.

FIG. 2 is a graph of change over time in the hydrogen sulfide gas concentration measured in the state of FIG. 1.

FIG. 3 is a graph showing change over time in the concentration of hydrogen sulfide gas generated by mixing a mixture of rice husks: 10 mL and bark compost with cow manure: 10 mL, with untreated waste water generated by mining operations (pH: 5.91, Cd ion concentration: 0.1 mg/L, SO₄²⁻ concentration: 250 mg/L): 20 mL. Note that FIG. 3 also shows the results of a case where the organic matter is rice husks alone: 20 mL shown in FIG. 2 and a case where the organic matter is bark compost with cow manure alone: 20 mL shown in FIG. 2.

FIG. 4(a) is a photograph showing a state of a column before being loaded with silica or organic matter, and FIG. 4(b) is a diagram schematically showing a state where water is continuously flown through a biological purification system 100 according to an embodiment of the present invention.

FIG. 5 is a photograph showing a state where water is actually flown continuously through columns.

FIGS. 6(a) to 6(d) are graphs each showing change over time in the water quality of treated water discharged from a column. The vertical axes represent the sulfate ion (SO₄²⁻) concentration in (a), the cadmium (Cd) ion concentration in (b), the zinc (Zn) ion concentration in (c), and the chemical oxygen demand (COD) in (d).

FIG. 7 is a photograph showing the color of the treated water discharged from columns after one week from the start of the experiment and illustrates a case where a mixture of rice husks and bark compost with cow manure, bark compost with cow manure alone, and rice husks alone shown from the left are separately used as organic matters.

FIG. 8 is a graph showing change over time in the sulfate ion (SO₄²⁻) concentration of the untreated waste water in using organic matter mainly containing buckwheat husks, and the untreated waste water in using organic matter mainly containing rice husks.

FIGS. 9A(a) and 9A(b) are graphs showing change over time in the water quality of the treated water discharged from a column. The vertical axes represent the sulfate ion (SO₄²⁻) concentration in (a) and the cadmium (Cd) ion concentration in (b).

FIGS. 9B(c) and 9B(d) are graphs showing change over time in the water quality of the treated water discharged from a column. The vertical axes represent the lead (Pb) ion concentration in (c) and the zinc (Zn) ion concentration in (d).

FIGS. 9C(e) and 9C(f) are graphs showing change over time in the water quality of the treated water discharged from a column. The vertical axes represent the copper (Cu) ion concentration in (e) and the chemical oxygen demand (COD) in (f).

### BEST MODE FOR CARRYING OUT THE INVENTION

Embodiments of the present invention will be described below with reference to the drawings to describe the present invention in more detail and the advantages.

(Biological Purifier for Untreated Waste Water)

A biological purifier according to the present invention is for removing heavy metal ions as sulfide from untreated waste water containing heavy metal ions and sulfate ions. Untreated waste water to which the present invention is directed is not limited as long as it contains heavy metal ions and sulfate ions; accordingly, the water may be, for example, wastewater generated by mining operations such as drainage from metal mines, industrial wastewater, and the like. Drainage from metal mines in our country (Japan) typically contains, for example, ions of heavy metals such as Fe, Zn, Cu, Pb, Ca, and As, and further contains about 50-3000 mg/L of sulfate ions (SO₄²⁻). Note that “untreated waste water” herein means water before being treated by purification using a biological purifier, that is, removal of heavy metal ions. Meanwhile, “treated water” means water having been treated by the purification. The pH of untreated waste water is typically about 3.5 to 8.0.

The present inventors have made studies on various methods using organic matter retaining sulfate-reducing bacteria (SRB) for treating untreated waste water to stably neutralize (make harmless) and remove heavy metal ions for a long period by taking advantage of biological purification function. Sulfate-reducing bacteria are heterotrophic bacteria taking an active part using organic components as an energy source in the presence of sulfate ions, and they function to reduce sulfate ion as shown in Formula (1) below. Specifically, sulfate-reducing bacteria have functions of taking up organic components and sulfate ions, and releasing hydrogen sulfide ions.

2CH₂O+SO₄²⁻=2HCO₃⁻+HS⁻+H⁺ (1)

wherein CH₂O is an organic component.

Sulfate-reducing bacteria are anaerobic bacteria primarily taking an active part in the neutral range (pH: 5 to 8), which take an active part using organic components as an energy source, and reduces sulfate ions. Although not limited thereto, they may be, for example, Desulfovibrio vulgaris, and the like.

As the reduction reaction in Formula (1) above (reaction in Formula (1) to the right) proceeds, hydrogen sulfide ions (HS⁻) are generated, and the generated hydrogen sulfide ions (HS⁻) are chemically combined with heavy metal ions in untreated waste water. Thus, heavy metal ions can be precipitated as sulfide to be neutralized by the reaction of Formula (2) shown below.

Me²⁺+HS⁻=MeS↓+H⁺ (2)

wherein Me is a heavy metal.

As described above, the present inventors found that, in order to achieve sufficient reduction reaction of sulfate ions as in Formula (1) above to effectively precipitate a heavy metal as sulfide, an appropriate organic matter source serving as an energy source for sulfate-reducing bacteria is required to be selected. For example, as will be described later in examples below, when known leaf mold was used as an organic matter source, sulfate-reducing bacteria were present in the leaf mold; however, reduction reaction of sulfate ions did not occur.

As will also be described later in the examples below, when a fertilizing organic matter source such as bark compost with cow manure was used as an organic matter source, heavy metal ions were sufficiently removed due to Formulas (1) and (2) above; however, organic matter was found to be mixed in the treated water, and water treated in an early stage of purification, in particular was found to be colored.

Therefore, the present inventors considered an organic matter source making it possible to achieve sufficient effect of removing heavy metal ions by Formulas (1) and (2), which is capable of sufficiently suppressing organic contamination of treated water. As a result, they found it fully effective to use chaff as an organic matter source useful for providing organic components that are energy sources for sulfate-reducing bacteria. Thus, they completed the present invention. Accordingly, a biological purifier according to the present invention is characterized by containing chaff retaining sulfate-reducing bacteria.

Moreover, chaff is a biomass resource which is wasted in normal situations, and they are readily available in large quantities at little cost. Further, they are granular in shape, easy to handle because they do not require processes such as cutting or crushing, and relatively uniform in quality. Therefore, the purifier of the present invention can be suitably applied to large-scale purification systems for treating large quantities of untreated waste water. As described in Patent Document 1 and Patent Document 2, chaff has been previously known as an adsorbent material for heavy metal ions; however, the present inventors were first to find a surprising fact that chaff can be used as an energy source for sulfate-reducing bacteria in a method of removing heavy metals using the action of sulfate-reducing bacteria.

When chaff is used as an adsorbent material for heavy metal ions, the effect of removing heavy metal ions lasts for about several hours to several days. Once an adsorption site in chaff traps heavy metal ions, the relevant adsorption site would lose its adsorption ability after that. In contrast, a purifier of the present invention is capable of continuously removing heavy metal ions as long as sulfate-reducing bacteria play an active part using chaff as feed. Therefore, heavy metal ions in untreated waste water can be removed for a longer period, for example, at least a half year or over more than one year.

The chaff is preferably fermented under anaerobic conditions. This is because fermented and decomposed chaff can be ingested as an energy source by sulfate-reducing bacteria, which results in increased activity of the sulfate-reducing bacteria. Consequently, the effects of removing heavy metal ions can be fully achieved.

Chaff here includes rice husks, wheat husks, buckwheat husks, and the like. Chaff collected from the nature generally retains sulfate-reducing bacteria under normal conditions without adding them. Chaff used in a purifier of the present invention needs to retain sulfate-reducing bacteria; namely, the chaff collected from the nature must not be subjected to any treatment which would kill the sulfate-reducing bacteria (for example, heat treatment and the like). In other words, not only chaff not having been subjected to any treatment, but also any chaff having been subjected to some treatment such as rinsing or natural seasoning, which would not kill sulfate-reducing bacteria, can be used. Obviously, sulfate-reducing bacteria may further be added to the collected chaff.

Other organic matters to be mixed as a biological purifier with chaff preferably have a sufficient effect of removing heavy metal ions due to Formulas (1) and (2), and may include, for example, the above-mentioned bark compost with cow manure and the like. In that case, the proportion of chaff in the mixture is preferably 50 vol % or more, more preferably, 75 vol % or more. The proportion of 50 vol % or more can maintain the effect of removing heavy metals, and can suppress organic contamination of treated water more sufficiently. In order to maximize the above-described benefit of the present invention, the purifier is preferably composed of raw (unprocessed) chaff alone.

However, when acidic untreated waste water with a pH of about 3.5 to 5.0 is treated, 5 vol % to 25 vol % of a pH adjuster such as bark compost with cow manure is preferably added as appropriate. Bark compost with cow manure makes the pH of untreated waste water closer to the neutral range, and the addition of sulfate-reducing bacteria in the material intensifies the activity of the sulfate-reducing bacteria in the reaction, which increases the effect of removing heavy metals. Other pH adjusters and bacterial sources include leaf mold, and the like other than bark compost with cow manure.

(Biological Purification System for Untreated Waste Water)

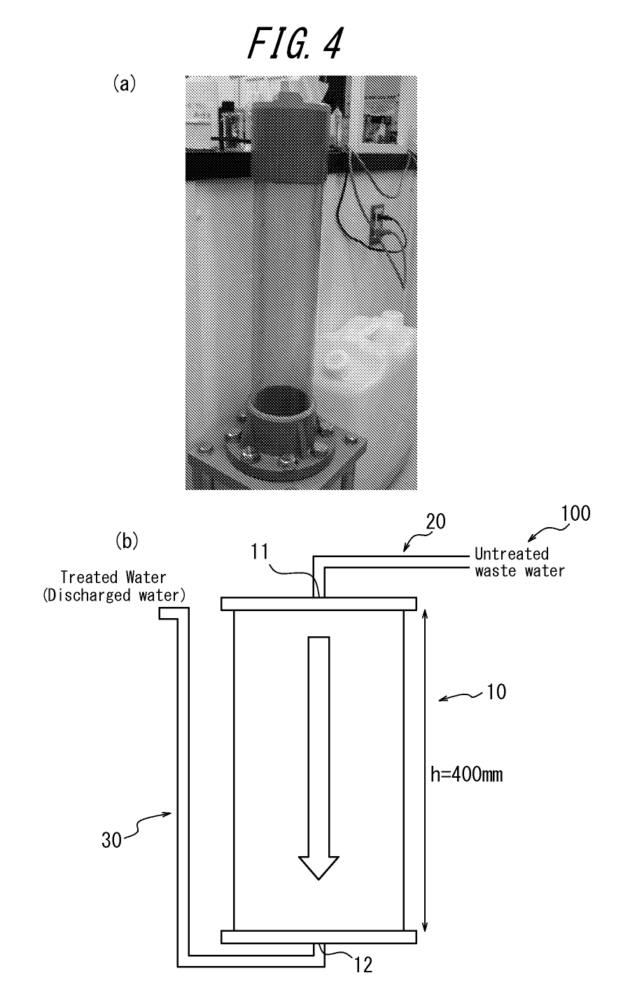

Embodiments of a biological purification system for untreated waste water, of the present invention will now be explained. A biological purification system 100 according to an embodiment of the present invention is characterized by including a treatment container 10 storing the above described biological purifier with anaerobic conditions maintained inside; a supply system 20 for supplying the untreated waste water into this treatment container 10; an discharge system 30 for discharging, from the treatment container 10, treated water from which heavy metal ions have been removed by the biological purifier inside the treatment container 10 as shown in FIG. 4(b), for example. This purification system uses a biological purifier using unutilized biomass resources which are wasted in normal situations to precipitate heavy metal ions in untreated waste water containing heavy metal ions and sulfate ions, as sulfide, which allows the heavy metal ions to be sufficiently removed for a long period and organic contamination of treated water to be sufficiently suppressed. Further, in this system, untreated waste water can be continuously flown through the purifier.

In order to achieve the effectiveness of the biological purifier, organic matter contained in the purifier is required to be fully fermented under anaerobic conditions to be decomposed before flowing the untreated waste water through the system 100 such that sulfate-reducing bacteria attached to the purifier are cultured and activated. In a specific technique, the treatment container 10 in a closed system such as a reactor is loaded with chaff serving as the purifier and water sealing is achieved by the untreated waste water. Then it is left to stand. Thus, the organic matter is fermented and decomposed under anaerobic conditions, which allows nutrient necessary for sulfate-reducing bacteria to be effectively supplied. Further, since the untreated waste water contains sulfate ions, sulfate-reducing bacteria attached to the purifier are cultured and activated in the reactor by the sulfate ions and the above nutrient. The above culturing is preferably performed in an environment at an ambient temperature of 15° C. or more and 30° C. or less for a leaving time of 2 weeks to 4 weeks. Basically, continuous purifying effect of the purifier can be expected by simply using the untreated waste water containing sulfate ions for water sealing, and using organic matter contained in the biological purifier as the nutrient.

The supply system 20 includes, for example, a pump (not shown) for supplying the untreated waste water to the treatment container 10, and a distributing pipe (FIG. 4(b)) connected to an inlet 11 at the top of the treatment container 10. Further, the discharge system 30 includes a distributing pipe (FIG. 4(b)) connected to an outlet 12 at the bottom of the treatment container 10.

The treatment container 10 may be a column when a column test is performed, and may be, for example, a reactor having a size of about 1000 m³ or an artificial wetland when relatively large-scale treatment is performed. Namely, a purification system of the present invention can be applied to an on-site system.

The purification system is preferably configured such that the untreated waste water can pass through the supply system, the treatment container, and the discharge system in this order with gravity. This configuration eliminates the use of a pump for bringing untreated waste water to the supply system or the discharge system, resulting in reduced system cost.

In a preferable structure of an illustrative embodiment, the supply system 20 is connected to the top of the treatment container 10, and the discharge system 30 is connected to the bottom of the treatment container 10 as shown in FIG. 4(b), so that heavy metal ions are removed in the process where untreated waste water passes through the treatment container 10 with gravity. This structure prevents clogging in the treatment container 10, and also prevents reduction in the activity of the sulfate-reducing bacteria in the reaction due to water directly lead to a lower part under more anaerobic conditions.

When the treatment container 10 is an artificial wetland or a large tank, in order to retain the anaerobic atmosphere, the supply system 20 may be connected to a lower part of the treatment container such that the untreated waste water is flown at the bottom in the treatment container 10. When the inlet of the supply system 20 for untreated waste water is placed at a position higher than the treatment container 10, the untreated waste water can be supplied into the treatment container using gravity irrespective of the position at which the supply system 20 is connected to the treatment container. Further, when the treatment container 10 is a permeable reactive barrier buried underground and the untreated waste water is groundwater, the flow of the groundwater can be used as the supply system 20 and the discharge system 30.

The residence time of untreated waste water in the treatment container 10, the amount of purifier with respect to the amount of the untreated waste water, and the like can be determined as appropriate depending on the concentration of heavy metal ions contained in the untreated waste water, the target concentration of heavy metal ions, and the like.

(Biological Purification Method for Untreated Waste Water)

Next, embodiments of a biological purification method for untreated waste water in accordance with the present invention will now be described.

The biological purification method for untreated waste water in accordance with the present invention is characterized in that the above biological purifier and untreated waste water are brought into contact with each other under anaerobic conditions to precipitate heavy metal ions as sulfide and remove the sulfide from the untreated waste water. This purification method uses a biological purifier using unutilized biomass resources which are wasted in normal situations to precipitate heavy metal ions in untreated waste water containing heavy metal ions and sulfate ions, as sulfide, which allows the heavy metal ions to be sufficiently removed for a long period and organic contamination of treated water to be sufficiently suppressed.

A purifier containing chaff retaining sulfate-reducing bacteria and untreated waste water containing heavy metal ions and sulfate ions are brought into contact with each other, so that the chaff is decomposed into organic components. Under the action of the sulfate-reducing bacteria ingesting the organic components produced by the decomposition as an energy source, the organic components and the sulfate ions are reacted to produce hydrogen sulfide ions. The heavy metal ions are reacted with the produced hydrogen sulfide ions to precipitate as sulfide, thereby separating the sulfide from the untreated waste water. Thus, the untreated waste water is naturally purified by simple contact with the purifier.

The concentration of the sulfate ions contained in the untreated waste water is preferably 1 mg/L or more, more preferably 50 mg/L or more in order to fully precipitate the heavy metal ions in the untreated waste water as sulfide.

The heavy metals may be Fe, Zn, Cu, Pb, Cd, As, and the like, but not limited thereto as long as they can be precipitated as sulfide in accordance with Formula (2) above. Note that the effluent standards with respect to heavy metal ions in Japan are prescribed in the Water Pollution Control Act (Act No. 105 of Aug. 30, 2011) and the Ordinance for Effluent Standards (Ordinance of the Ministry of the Environment No. 28 of Oct. 28, 2011). The standard values are for example, Cd ions: 0.1 mg/L, Pb ions: 0.1 mg/L, Zn ions: 2 mg/L, and Cu ions: 3 mg/L. According to the review by the present inventors, untreated waste water containing approximately Cd ions: 0.35 mg/L, Pb ions: 1.6 mg/L, Zn ions: 21 mg/L, and Cu ions: 15 mg/L can be purified in accordance with the present invention into treated water containing heavy metal ions within the standards.

Further, the untreated waste water is preferably mine drainage in terms of achieving significant effects of the present invention.

It should be noted that the foregoing descriptions merely show examples of embodiments of the present invention, and various modifications can be made to the accompanying claims. Moreover, all of a purifier, a purification system, and a purification method in accordance with the present invention can be applied to an on-site system.

### EXAMPLE

In order to further clarify the effects of the present invention, experiments were performed in accordance with the examples and comparative examples below.

### Experimental Example 1

### Discussion on Whether the Biological Purification Action Works or Not

The inventors discussed on whether organic matter of various kinds, specifically, three kinds of organic matters, bark compost with cow manure (Comparative Example), leaf mold (Comparative Example), and rice husks (biological purifier of the present invention example) have biological purification functions or not.

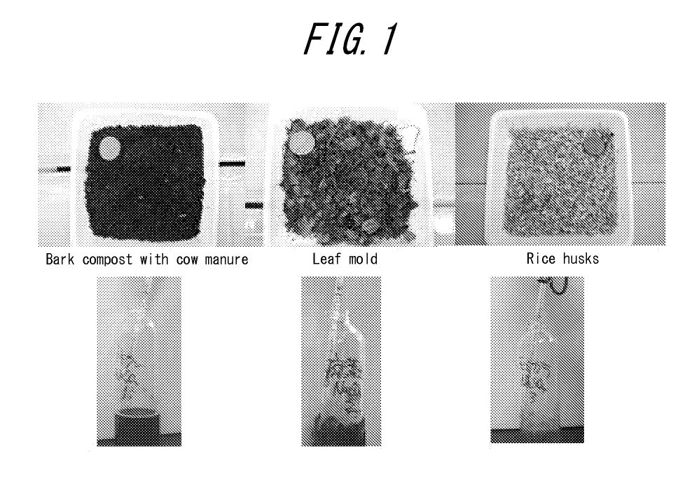

The upper photographs in FIG. 1 show bark compost with cow manure, leaf mold, and rice husks from the left, which have not been subjected to any process. The bark compost with cow manure, leaf mold, and rice husks themselves retain sulfate-reducing bacteria (SRB) without any addition of sulfate-reducing bacteria (SRB). The lower photographs in FIG. 1 show a state where each of the organic matters: 20 mL and untreated waste water generated by mining operations (pH: 5.91, Cd ion concentration: 0.1 mg/L, SO₄²⁻ concentration: 250 mg/L): 20 mL were mixed in a 100 mL vial, and left under an environment of 30° C. after nitrogen purge, and gas collected out of a vial using a gas sampling pump (GV-100 manufactured by Gastec Corporation) is introduced into hydrogen sulfide detector tubes (any of four types: 4LL, 4L, 4M, and 4HM manufactured by Gastec Corporation) of different measurement ranges, thereby measuring the concentration of hydrogen sulfide gas generated in the vial. Higher concentration of hydrogen sulfide measured here indirectly indicates that sulfate-reducing bacteria in the organic matters are active, and the heavy metal ions contained in untreated waste water were easily precipitated as sulfide.

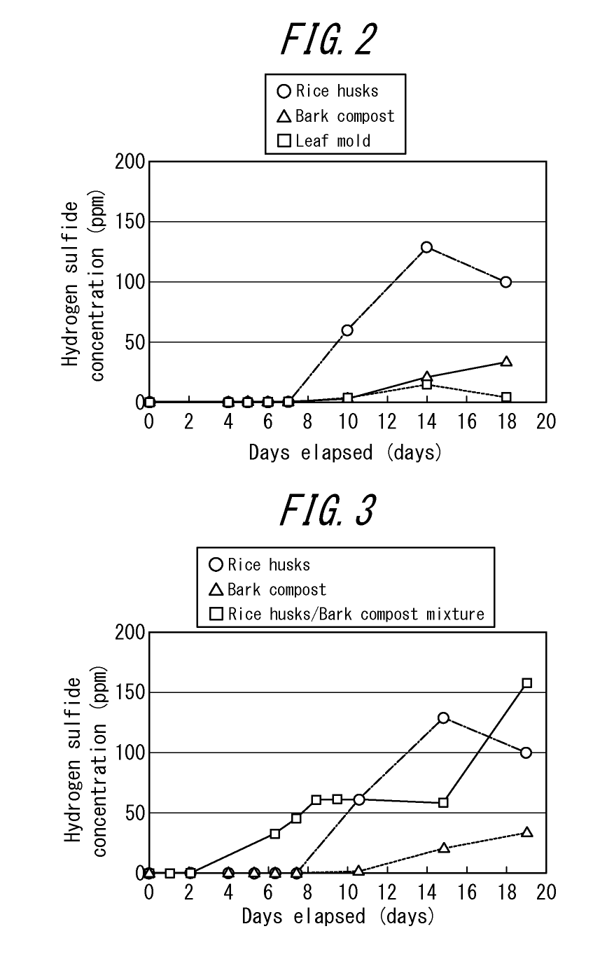

FIG. 2 is a plot showing the results of measuring the hydrogen sulfide gas concentration on the vertical axis and the number of days elapsed on the horizontal axis with respect to the three kinds of organic matters, namely, bark compost with cow manure (simply referred to as “(bark compost)” in FIG. 2), leaf mold, and rice husks.

In the results shown in FIG. 2, hydrogen sulfide (H₂S) gas was generated after ten days from the start of the test in using the rice husks, which was earliest of the three kinds of organic matters, and even after that, the concentration of the hydrogen sulfide gas generated remained high. On the other hand, hydrogen sulfide gas was generated in the bark compost with cow manure and leaf mold after 14 days from the start of the test, which is four days after the generation in the rice husks. Hydrogen sulfide gas was observed to be continuously generated after that in the bark compost with cow manure; however, little hydrogen sulfide gas was generated in the leaf mold afterward. Further, since the concentration of the hydrogen sulfide (H₂S) in the rice husks had been higher than the others during the test, it is inferred that more heavy metal ions in the untreated waste water were precipitated as sulfide.

From this, it was understood that the rice husks were quite preferable as an organic matter source for sufficient reduction reaction of sulfate ions; meanwhile, little reduction reaction of sulfate ions occurred in the leaf mold, and less reduction reaction of sulfate ions occurred as well in the bark compost with cow manure as compared with the rice husks.

Next, FIG. 3 shows the results of measuring the concentration of hydrogen sulfide gas generated in gas detector tubes after a mixture of rice husks: 10 mL and bark compost with cow manure: 10 mL (a biological purifier of the present invention example, labeled rice husks/bark compost mixture in FIG. 3), and untreated waste water generated by mining operations (pH: 5.91, Cd ion concentration: 0.1 mg/L, SO₄²⁻ concentration: 250 mg/L): 20 mL were mixed in a 100 mL vial and left under an environment of 30° C. after nitrogen purge. FIG. 3 also shows plots of the case where the organic matter is rice husks: 20 mL and the case where the organic matter is bark compost with cow manure (bark compost): 20 mL as in FIG. 2.

In the results of FIG. 3, when the mixture in which rice husks and bark compost with cow manure were mixed at a volume ratio of 1:1 was used as organic matter, hydrogen sulfide (H₂S) gas was generated about one week earlier than the case of using the bark compost with cow manure alone. Further, the hydrogen sulfide concentration was increased to significantly high levels, and almost the same hydrogen sulfide concentration as the case of using rice husks alone was observed. Thus, the purifier containing the rice husks was found to cause sufficient reduction reaction of sulfate ions.

### Experimental Example 2

### Column Test

Next, a test performed for removing heavy metal (Cd, Zn) ions contained in real drainage from metal mines (untreated waste water) will be described below. The following three biological purifiers were used. That is, a purifier of rice husks alone and a purifier of a mixture in which rice husks and bark compost with cow manure had been mixed at a volume ratio of 1:1 were used as biological purifiers of the present invention examples, and a purifier of bark compost with cow manure alone was used as a biological purifier of Comparative Example.

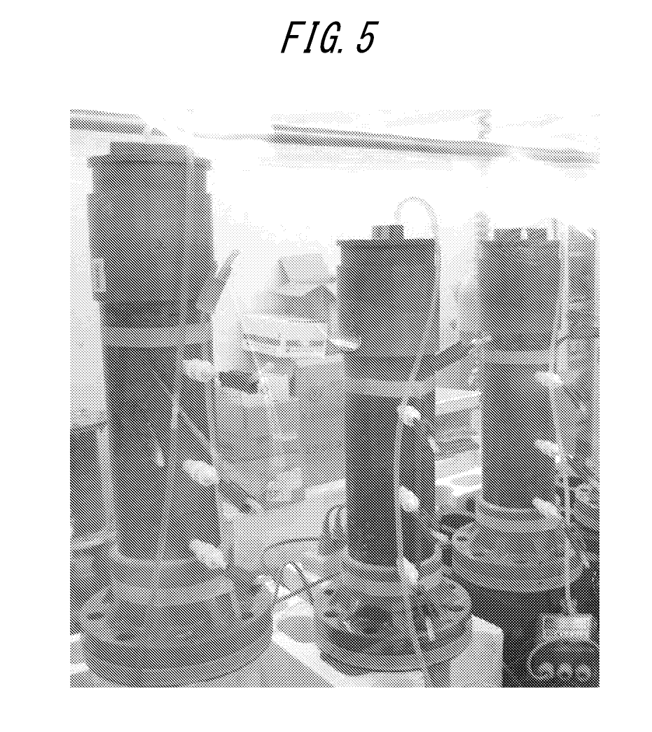

A column (reactor) having a height of 400 mm and a diameter of 100 mm was loaded with organic matter (a purifier of the present invention example or of Comparative Example) to be nutrient for sulfate-reducing bacteria and silica for ensuring gap inside the column that had been mixed at a volume ratio of 1:1. The untreated waste water was introduced into the column, and left to stand for three weeks for breeding the sulfate-reducing bacteria. After that, the untreated waste water was continuously flown through the column from the top to the bottom for a residence time of 50 hours, and water quality change in the treated water discharged from the column was examined. The untreated waste water used was mine seepage water (drainage) with water quality shown in Table 1. FIG. 4(a) is a photograph showing a state of a column before being loaded with silica or organic matter, and FIG. 4(b) is a diagram schematically showing a state where water is continuously flown through the column. FIG. 5 is a photograph showing a state where water is actually flown continuously through columns.

TABLE 1
Water quality of Mine seepage water

| | Components (mg/L) | | | | |
|---|---|---|---|---|---|
| pH | Cd | Pb | Zn | Fe | SO₄²⁻ |
| 5.91 | 0.103 | 0.019 | 1.971 | 0.371 | 250 |

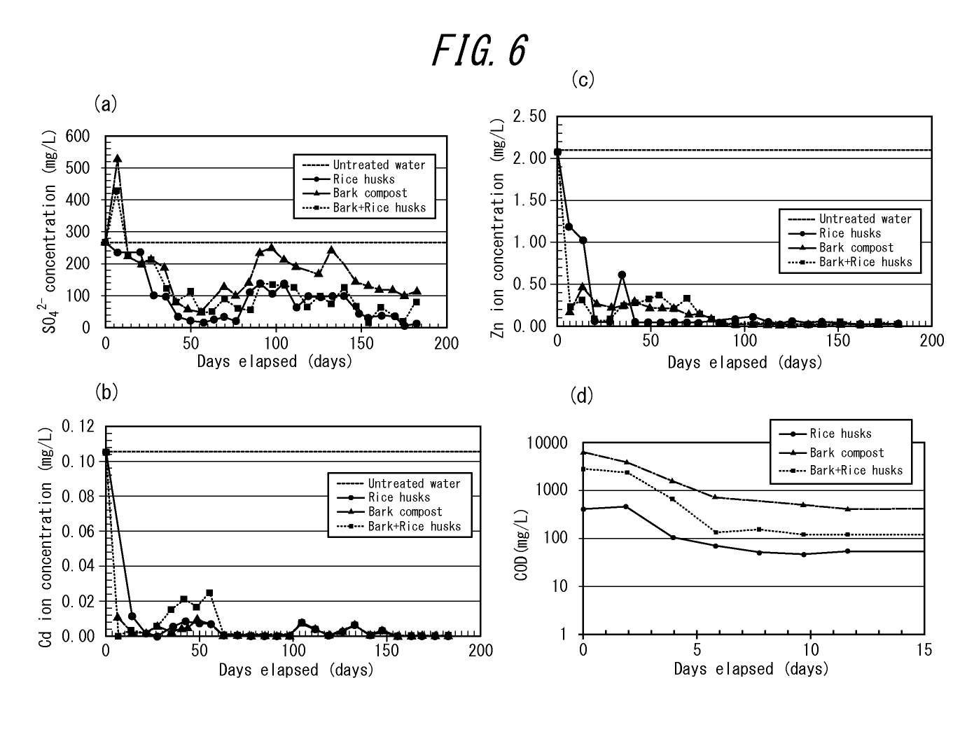

The effluent standards with respect to heavy metal ions, prescribed in accordance with the Water Pollution Control Act (Act No. 105 of Aug. 30, 2011) and the Ordinance for Effluent Standards (Ordinance of the Ministry of the Environment No. 28 of Oct. 28, 2011) include Cd ions: 0.1 mg/L, Pb ions: 0.1 mg/L, Zn ions: 2 mg/L, and Fe ions: 10 mg/L; therefore, the amounts of Cd ions and Zn ions contained in the untreated waste water exceed the standards. Accordingly, the concentrations of the two kinds of heavy metal ions were measured. In addition, the sulfate ion (SO₄²⁻) concentration and the chemical oxygen demand (COD) were also measured. Reduction in sulfate ions indicates generation of hydrogen sulfide ions due to reduction of sulfate ions; meanwhile, low COD indicates low organic contamination in the treated water. FIGS. 6(a) to 6(d) are plots each showing change over time in the water quality of treated water discharged from the column. The vertical axes represent the sulfate ion (SO₄²⁻) concentration in (a), the cadmium (Cd) ion concentration in (b), the zinc (Zn) ion concentration in (c), and the chemical oxygen demand (COD) in (d). FIGS. 6(a) to 6(c) also show data in the case without loading with organic matter, with a broken line (labeled untreated water in FIGS. 6(a) to 6(c)).

In the results in FIG. 6(a), the concentration of sulfate ions in the treated water is likely to decrease even when any one of the three kinds of purifiers is used; however, the concentration of sulfate ions is significantly likely to decrease when one of the two kinds of purifiers containing rice husks that are the present invention examples are used in particular. Thus, reduction reaction of sulfate ions, which is required for removing heavy metal ions as sulfide, was observed to proceed sufficiently. In FIG. 6(a), a phenomenon in which the concentration of sulfate ions fluctuates over time is observed and is considered to be caused, for example, by variation over time in the activity state of the sulfate-reducing bacteria present in the column.

The results of FIG. 6(b) and FIG. 6(c) show that the concentrations of Cd ions and Zn ions in the treated water fall below the detection limit when using any one of the three kinds of purifiers.

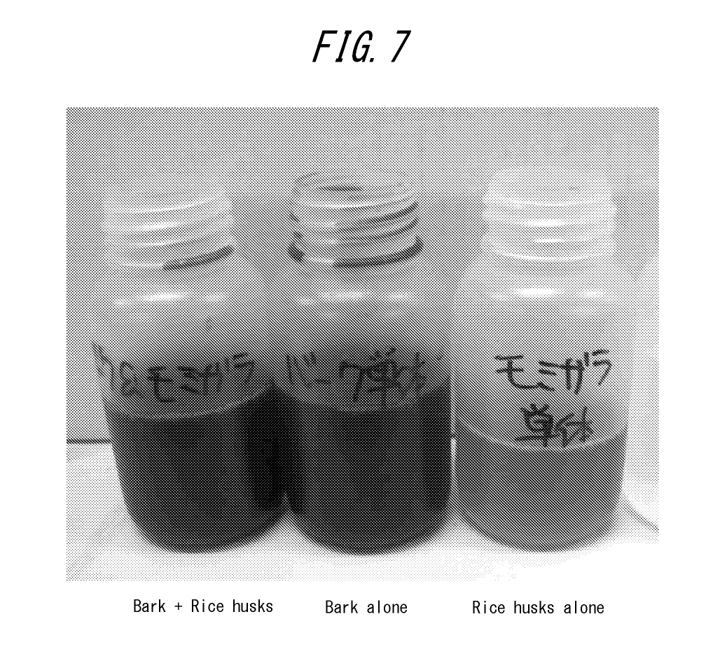

However, the results of FIG. 6(d) show that when the purifiers containing rice husks according to the present invention example were used, the COD values of the treated water treated in an early stage was low as compared with the purifier of Comparative Example, so that contamination due to organic matter inside the columns was suppressed. Further when a purifier of the present invention example, which is a purifier including rice husks alone was used, the COD value was lowest, and organic contamination was most suppressed. These tendencies were particularly apparent immediately after the start of the test (the elapsed days: 0 day). FIG. 7 is a photograph showing the color of the treated water discharged from the column after one week from the start of the test and illustrates a case where purifiers of a mixture of rice husks and bark compost with cow manure, bark compost with cow manure alone, and rice husks alone shown respectively from the left. The treated water discharged from the columns containing bark compost seems to have significantly muddy color as compared with the case of using the rice husks alone.

From the above results, it was found that a purifier of the present invention example can provide sufficient effect of removing heavy metal ions, and can also sufficiently suppress organic contamination (COD value and coloring) of the treated water.

### Experimental Example 3

### Measurement for Biological Purification Functions of Buckwheat Husks

Biological purification function of buckwheat husks as chaff other than rice husks was examined by the following test.

Fifteen grams of a purifier in which buckwheat husks and bark compost with cow manure were mixed at a volume ratio of 95:5 and 150 mL of untreated waste water generated by mining operations, shown in the row of “Experimental Example 3” in Table 2 below were mixed in a 250 mL plastic bottle, and left to stand under an environment of 30° C. after nitrogen purge. Change over time in the concentration of sulfate ions in the untreated waste water was measured using an ion chromatograph (ICA-2000 manufactured by DKK-TOA). Lower sulfate ion concentration indicates that sulfate-reducing bacteria are more active, which facilitates the removal of heavy metals.

Another experiment which is similar to the above experiment except for that the rice husks were replaced with buckwheat husks was also performed.

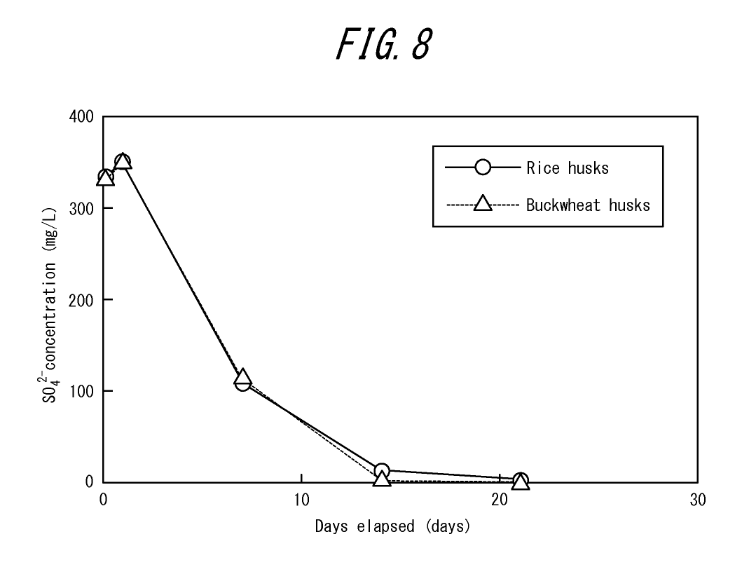

As shown in FIG. 8, the sulfate ion concentration significantly decreased as time passed also in a case of using a purifier containing buckwheat husks as in the case of using a purifier containing rice husks, indicating that sulfate ions were reduced to produce hydrogen sulfide ions.

Note that ORP (oxidation-reduction potential: mV) of each untreated waste water was measured using an ORP meter (RM-20P manufactured by DKK-TOA). Lower ORP indicates that the untreated waste water is under anaerobic conditions, which allows sulfate-reducing bacteria to work actively. Accordingly, the ORP of the untreated waste water, which was originally 220 mV, decreased after all as days passed to reach about −200 mV on the seventh day and was thereafter maintained at the same level.

Further, the pH of the untreated waste water was measured using a pH meter (D-54 manufactured by HORIBA) to find that the pH was initially 3.87 but rose to 6 to 7 immediately after the start of the experiment, and was thereafter maintained at the same level. This is considered to be due to the fact that the pH buffering effect of the bark compost with cow manure allowed the pH of the untreated waste water to be brought closer to the neutral range.

The above results show that buckwheat husks have sufficient effect of removing heavy metal ions as with the rice husks. The buckwheat husks do not contain any fertilizing component as rice husks don't; therefore, organic matter is not mixed in the treated water, so the treated water is expected to suffer from little organic contamination.

### Experimental Example 4

### Column Test

In order to demonstrate the effect of a purifier of the present invention in removing heavy metals from various kinds of untreated waste water, acidic untreated waste water in particular, the following experiment was carried out.

A 3 L column was loaded with a purifier made of a mixture of 0.75 L of rice husks and 0.75 L of bark compost with cow manure, and 1.5 L of silica. The untreated waste water shown in Table 2 was introduced into the column, and left to stand for three weeks for breeding sulfate-reducing bacteria. After that, the untreated waste water was continuously flown through the column from the top to the bottom for a residence time of 50 hours, and water quality change in the treated water discharged from the column was examined. The untreated waste water used was six kinds of mine seepage waters (drainage) collected in different mines or periods, and were tested separately in six columns. Table 2 also shows the effluent standards of the foregoing heavy metal ions.

TABLE 2

| Untreated | | Components (mg/L) | | | | | |
|---|---|---|---|---|---|---|---|
| waste water | pH | Cd | Pb | Zn | Fe | Cu | SO₄²⁻ |
| Experimental | 5.91 | 0.103 | 0.019 | 1.971 | 0.371 | — | 250 |
| Example 2 | | | | | | | |
| Experimental | 3.87 | 0.081 | 0.484 | 11.68 | — | 5.396 | 337 |
| Example 3 | | | | | | | |
| Experimental | 4.47 | 0.013 | 0.232 | 2.432 | — | 0.082 | 103.5 |
| Example 4 | | | | | | | |
| Experimental | 3.55 | 0.044 | 0.917 | 7.438 | — | 3.699 | 223.7 |
| Example 4 | | | | | | | |
| Experimental | 3.51 | 0.150 | 0.734 | 13.92 | — | 6.266 | 160.9 |
| Example 4 | | | | | | | |
| Experimental | 3.70 | 0.030 | 0.034 | 12.452 | — | 1.388 | 548.3 |
| Example 4 | | | | | | | |
| Experimental | 6.46 | 0.013 | 0.039 | 3.835 | — | 0.656 | 335.8 |
| Example 4 | | | | | | | |
| Experimental | 5.87 | 0.010 | 0.045 | 2.174 | — | 0.004 | 172.5 |
| Example 4 | | | | | | | |
| Standards | — | 0.1 | 0.1 | 2 | 10 | 3 | — |

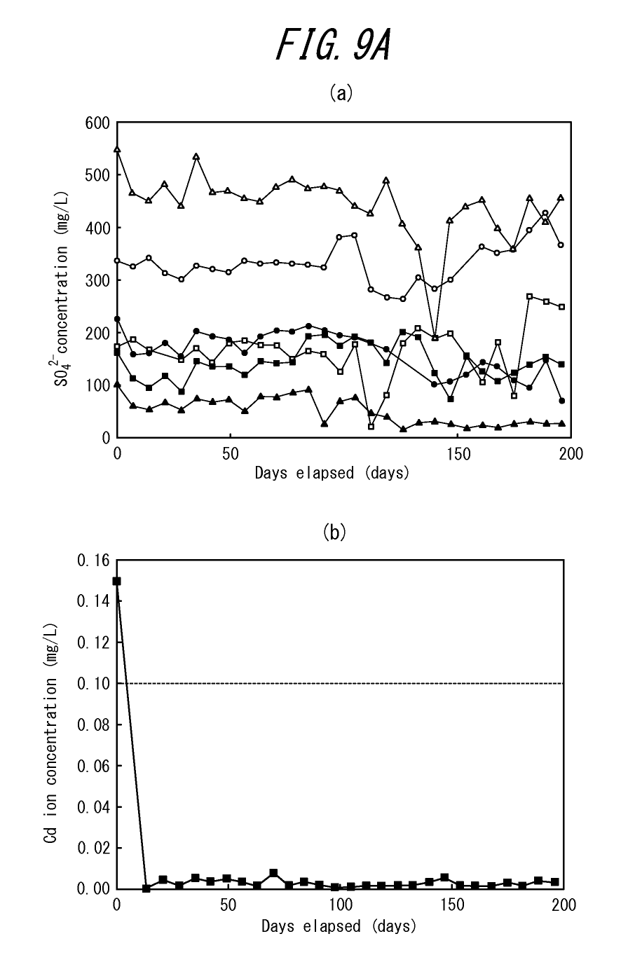

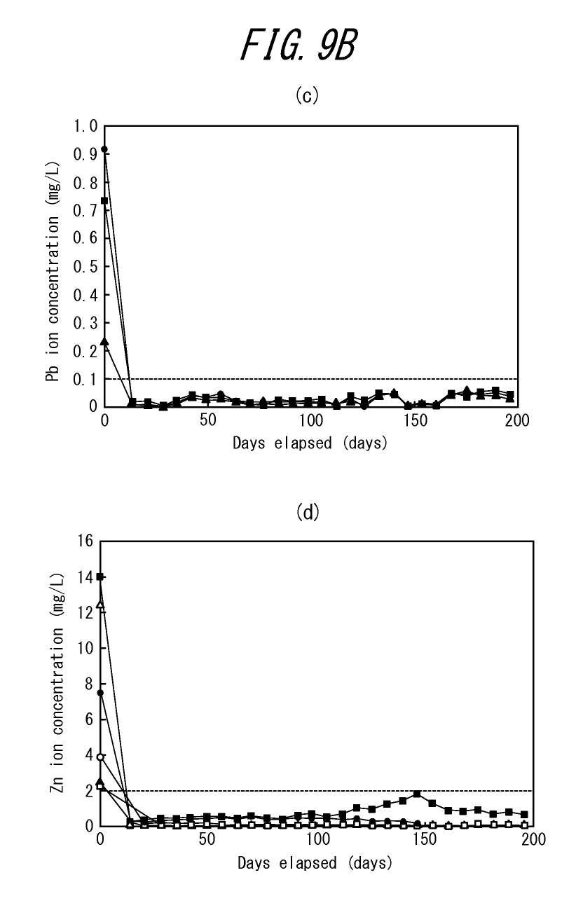

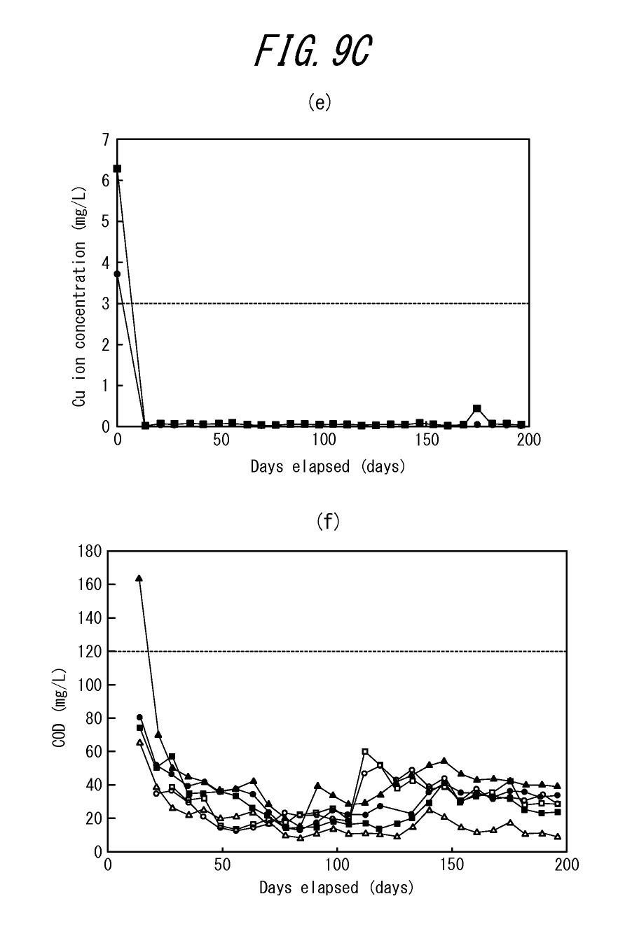

The change over time in the concentration of heavy metal ions exceeding the standards in each untreated waste water was measured. In addition, the sulfate ion (SO₄²⁻) concentration and the chemical oxygen demand (COD) were also measured. The results are shown in FIGS. 9(a) to 9(f). FIGS. 9(b) to 9(f) also show the effluent standards with broken lines.

In the result of FIG. 9(a), the sulfate ion concentration was consistently maintained at levels the same as the level at the introduction or lower than the level for over half a year; accordingly, sulfate ions are assumed to be reduced by sulfate-reducing bacteria. In the results of FIGS. 9(b) to 9(e), no heavy metals exceeding the effluent standards were detected in the treated water of all the columns. Thus, the purifiers of this experimental example were found to maintain the effect of removing heavy metals from various kinds of untreated waste water for a long period at least for over half a year.

The result in FIG. 9(f) shows that the COD values were under the waste water standard (120 mg/L) except for immediately after the start of the test, and organic contamination was fully suppressed.

### INDUSTRIAL APPLICABILITY

According to the present invention, a biological purifier including unutilized biomass resource capable of sufficiently removing heavy metal ions in untreated waste water that contains heavy metal ions and sulfate ions for a long period and capable of sufficiently suppressing organic contamination of treated water; a biological purification system using the biological purifier; and a biological purification method using the biological purifier can be provided. Chaff is an unutilized biomass resource which had been wasted as unnecessary waste product; therefore, making effective use of chaff is good for the environment. Further, the material cost of the purifier can be saved. Thus, the present inventions are highly applicable in the industry. Moreover, a biological purification method of the present invention only requires supplies of chaff forming the biological purifier at predetermined intervals; thus, natural purifying action can be easily maintained and controlled.

### EXPLANATION OF REFERENCE NUMERALS

100: Biological purification system
10: Column (Treatment container)
11: Inlet
12: Outlet
20: Supply system
30: Discharge system

1. A biological purifier for untreated waste water containing heavy metal ions and sulfate ions to remove the heavy metal ions from the untreated waste water as sulfide, comprising chaff retaining sulfate-reducing bacteria.

2. The biological purifier for untreated waste water according to claim 1, wherein the chaff is fermented under anaerobic conditions.

3. The biological purifier for untreated waste water according to claim 1, wherein the chaff is rice husks or buckwheat husks.

4. A biological purification system for untreated waste water containing heavy metal ions and sulfate ions to remove the heavy metal ions from the untreated waste water, comprising:
a treatment container in which anaerobic conditions are maintained, and the biological purifier according to claim 1 is stored;
a supply system for supplying the untreated waste water into the treatment container; and
a discharge system for discharging treated water from which the heavy metal ions have been removed in the treatment container by the biological purifier, from the treatment container.

5. The biological purification system for untreated waste water according to claim 4, configured such that the untreated waste water can pass through the supply system, the treatment container, and the discharge system in this order with gravity.

6. A biological purification method for untreated waste water containing heavy metal ions and sulfate ions to remove the heavy metal ions from the untreated waste water, wherein the biological purifier according to claim 1 and the untreated waste water are brought into contact with each other under anaerobic conditions, thereby precipitating and removing the heavy metal ions as sulfide from the untreated waste water.

7. The biological purification method for untreated waste water according to claim 6, wherein the untreated waste water is mine drainage.

8. The biological purifier for untreated waste water according to claim 2, wherein the chaff is rice husks or buckwheat husks.

9. A biological purification system for untreated waste water containing heavy metal ions and sulfate ions to remove the heavy metal ions from the untreated waste water, comprising:
a treatment container in which anaerobic conditions are maintained, and the biological purifier according to claim 2 is stored;
a supply system for supplying the untreated waste water into the treatment container; and
an discharge system for discharging treated water from which the heavy metal ions have been removed in the treatment container by the biological purifier, from the treatment container.

10. A biological purification system for untreated waste water containing heavy metal ions and sulfate ions to remove the heavy metal ions from the untreated waste water, comprising:
a treatment container in which anaerobic conditions are maintained, and the biological purifier according to claim 3 is stored;
a supply system for supplying the untreated waste water into the treatment container; and
an discharge system for discharging treated water from which the heavy metal ions have been removed in the treatment container by the biological purifier, from the treatment container.

11. A biological purification method for untreated waste water containing heavy metal ions and sulfate ions to remove the heavy metal ions from the untreated waste water, wherein the biological purifier according to claim 2 and the untreated waste water are brought into contact with each other under anaerobic conditions, thereby precipitating and removing the heavy metal ions as sulfide from the untreated waste water.

12. A biological purification method for untreated waste water containing heavy metal ions and sulfate ions to remove the heavy metal ions from the untreated waste water, wherein the biological purifier according to claim 3 and the untreated waste water are brought into contact with each other under anaerobic conditions, thereby precipitating and removing the heavy metal ions as sulfide from the untreated waste water.
